(19) United States
(12) Patent Application Publication
(10) Pub. No.: US 2004/0026311 A1
(43) Pub. Date: Feb. 12, 2004

(54) Method and apparatus for determining water separation characteristics of hydrocarbon fuels

(76) Inventor: Farrell R. Edmondson, Sarasota, FL (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/627,380

(22) Filed: Jul. 25, 2003

Related U.S. Application Data
(60) Provisional application No. 60/401,876, filed on Aug. 8, 2002.

(51) Int. Cl. B01D 17/022

(52) U.S. Cl. 210/445; 210/446; 210/489

(57) ABSTRACT

Apparatus for determining water separation characteristics of hydrocarbon fluids which includes a water/fuel separator for treating a water/fuel emulsion and measuring the water separability of the transient fluid to determine the water separation characteristics.

This application claims the benefit of U.S. provisional patent application Serial No. 60/401,876, filed Aug. 8, 2002.

### BACKGROUND OF THE INVENTION

1. Field of the Invention: Water separation characteristics of jet and diesel fuels can be degraded if surface active agents, commonly referred to as surfactants, are introduced into the fuels during production, storage, or distribution of the fuels.

2. Description of the Prior Art: Apparatus is available for detecting the presence of surfactants in fuels by determining how effectively undissolved (free) water can be removed from the fuel when the fuel is passed through a filter separator. Through a series of timed events measured quantities of fuel and distilled water are emulsified; passed through a coalescer cell; and a numerical rating (MSEP) based on the amount of uncoalesced water remaining in the fuel sample is obtained using a turbidimeter. High ratings are a result of ease of water coalescence and indicate that the fuel being tested is relatively free of surfactants.

### SUMMARY OF THE INVENTION

It is a desideratum of the invention to produce a method and apparatus for determining the water coalescence of transient hydrocarbon fuels as an indicator of the existence of surfactants in the fuel.

Another object of the invention is to produce a method and apparatus for removing undissolved water from transient hydrocarbon fuels wherein the effectiveness of the water removal is a function of the presence of surfactants in the fuel.

Another object of the invention is to produce a method and apparatus for removing undissolved water from a quantity of hydrocarbon fuel wherein the required skill of the operator of the apparatus is minimal.

The above objects as well as others may typically be achieved by a coalescing element for separating water from hydrocarbon fluids comprising a first body portion having a fluid conduit with an inlet and an associated outlet; a second body portion having a fluid conduit with an inlet and an associated outlet; and a filter separator pad, the second body portion adapted to be interconnected with the first body portion wherein the separator pad is disposed between the outlet of the second body portion and the inlet of the first body portion.

### BRIEF DESCRIPTION OF THE DRAWINGS

The above objects and advantages of the invention will become readily apparent to those skilled in the art from reading the following detailed description of the invention when considered in the light of the accompanying drawings, in which

FIG. 1 is an exploded view of the coalescer filter of the apparatus of the invention; and

FIG. 2 is a perspective view of the assembled coalescer illustrated in FIG. 1 with portions cut away to more clearly show the structure.

### DETAILED DESCRIPTION OF THE PREFERRED EMBODIMENT OF THE INVENTION

Referring to the drawings, there is illustrated a disposable coalescer utilized in testing of the water separation characteristics of hydrocarbon fluids.

Water separation characteristics of hydrocarbon fluids such as jet and diesel fuels, for example, can be degraded when surface active agents (surfactants) are introduced into the fluid during production, storage, or distribution. The presence of surfactants may typically be detected by determining how effectively undissolved (free) water can be removed when the fluid is passed through a filter separator.

It has been found that by emulsifying measured quantities of fuel and distilled water and passing the emulsion through a coalescer element, a numerical rating (MSEP) based on the amount of uncoalesced water remaining in the fuel sample, may be obtained. High minimal ratings indicate ease of water coalescence and the fuel is relatively free of surfactants.

The method employed in obtaining the numerical rating (MSEP) involves the following basic steps. Initially, a measured quantity of water, typically distilled water, is injected into a syringe filled with a given quantity of fuel being tested.

Next, a water/fuel emulsion is formed by rapidly mixing the water and fuel sample for a predetermined time period.

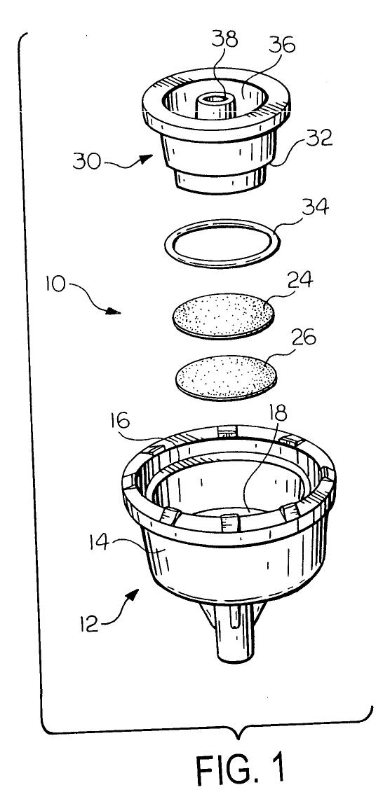

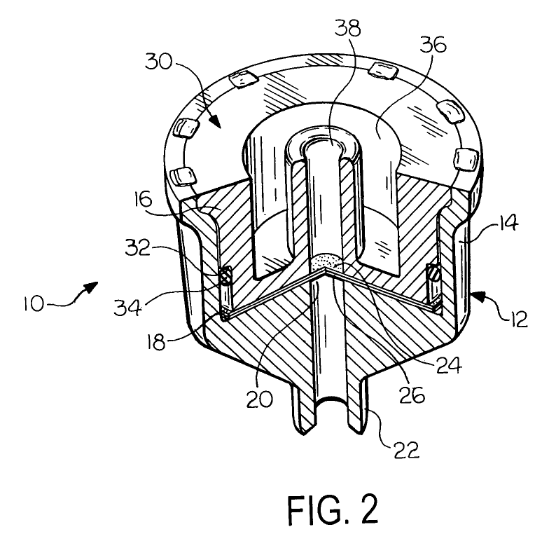

The following step involves affixing a disposable coalescing element 10, generally illustrated in FIGS. 1 and 2, to the inlet/outlet end of the above referred to syringe. The coalescer element 10 includes a hollow main body 12 typically cast from an aluminum alloy. The body 12 is provided with an annular upper portion 14 wherein the inner surface contains an annular shoulder 16 and a spaced apart bottom wall 18. A fluid conduit 20 is disposed centrally of the bottom wall 18 and communicates with a tubular outlet 22.

A pair of coalescer discs 24, 26 are disposed in superposed relation on the bottom wall 18 of the main body 12. The discs 24 and 26 are securely held against the bottom wall 18 by the insertion of an annular body portion 30 which may be secured to the main body 12 by being staked thereto as clearly illustrated in FIG. 2. The body portion 30 is typically cast from an aluminum alloy and is provided with a downwardly facing shoulder 32. The shoulder 32 is adapted to receive an elastomeric O-ring 34. The O-ring 34 is effective to produce a fluid-tight seal between the inner surface of the hollow interior wall of the body 12 and the outer surface of the body portion 30.

The body portion 30 is provided with a hollow interior 36 and a hollow upstanding concentric central member having fluid conduit 38 with an inlet at one end and an outlet at the opposite end. In the assembled form, the fluid conduit 38 of the body portion 30 is aligned with the fluid conduit 20 of the main body 12.

The upper coalescer disc 24 is typically 0.024 inches thick and a radius of approximately 7/16 inches. The disc 24 has an upper layer of cured fiberglass and has a lower layer of scrim. The lower coalescer disc 26 is typically 0.017 inches thick and a radius of approximately 7/16 inches. The disc 26 has an upper layer of cured fiberglass and a lower layer of scrim. The discs 24 and 26 are formed of material punched from commercially available products manufactured by Hollingsworth & Vose and sold under the product designation of LD-2021 O-A and LA-8141 O-A, respectively.

The coalescer element 10 is attached to a syringe in such a fashion that the syringe inlet/outlet is fitted over the upstanding inlet end of the fluid conduit 38 such that the stream of emulsion from the syringe may be caused to travel through the conduit 38 and thence through the upper and lower coalescer discs 24 and 26, respectively. After passage through the discs 24 and 26, the treated emulsion is ejected through the tubular outlet 22 and finally collected in a test container.

The water separability of the collected sample fuel is typically measured by a photocell and an associated meter.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A coalescing element for separating water from hydrocarbon fluids comprising:
a first body position having a fluid conduit with an inlet and an associated outlet;
a second body portion having a fluid conduit with an inlet and an associated outlet; and
filter separator pad, said second body position adapted to be interconnected with said first body portion wherein said separator pad is disposed between the outlet of said second body portion and the inlet of said first body portion.

2. A coalescing element as defined in claim 1 wherein said first body portion includes a cylindrical wall having an open top and a closed bottom through which the fluid conduit travels.

3. A coalescing element as defined in claim 2 wherein said second body portion is received within the cylindrical wall of said first body portion.

4. A coalescing element as defined in claim 3 wherein the fluid conduit of said second body portion is aligned with the fluid conduit of said first body portion.

5. A coalescing element as defined in claim 1 wherein said first body portion and said second body portion are interconnected in a fluid-tight relationship.

6. A coalescing element as defined in claim 3 wherein the inlet of the fluid conduit of said first body portion extends from the closed bottom thereof.

7. A coalescing element as defined in claim 1 wherein said filter separator pad is formed of fiberglass.

8. A coalescing element as defined in claim 7 wherein said filter separator pad is disc-shaped.

9. A coalescing element as defined in claim 8 wherein said filter separator pad is formed of a plurality of superposed disc-shaped elements.

10. A coalescing element as defined in claim 9 wherein at least one of said superposed disc-shaped elements is reinforced by a scrim material.
